(19) United States
(12) Patent Application Publication
(10) Pub. No.: US 2026/0318283 A1
(43) Pub. Date: Oct. 15, 2026

(54) LOAD REDUCTION METHOD IN WIND TURBINES

(71) Applicant: VESTAS WIND SYSTEMS A/S, Aarhus N (DK)

(72) Inventors: Morten Bagger SØGAARD, Thisted (DK); Waseem AHMED SHAIK, Nellore (IN); Alun JONES, Hørning (DK); Balaji P M, Kattupakkam, Chennai (IN)

(21) Appl. No.: 19/106,591

(22) PCT Filed: Sep. 29, 2023
(86) PCT No.: PCT/DK2023/050233

§ 371 Date: Feb. 25, 2025

(30) Foreign Application Priority Data
Sep. 30, 2022 (IN) 202211056440
Nov. 14, 2022 (DK) PA202270549

(51) Int. Cl. F03D 80/00; F03D 7/02; H02J 3/14; H02J 11/00

(52) U.S. Cl. CPC F03D 80/003; F03D 7/0284; H02J 3/14; H02J 11/00; F05B 2270/10711; F05B 2270/337

(57) ABSTRACT

The present invention relates to a method for operating a wind turbine during an undervoltage event where a grid voltage drops to an undervoltage value, wherein the wind turbine comprises a generator being operatively connected to a power grid, an auxiliary system comprising one or more auxiliary electrical components and one or more auxiliary electrical loads, an auxiliary transformer being operatively connected on a primary side to the generator and to the power grid, and being operatively connected on a secondary side to the auxiliary system, and a load controller being arranged to reduce one or more auxiliary electrical loads in the auxiliary system in response to a detected undervoltage event, the method comprising the steps of determining, using the load controller, that an undervoltage event has occurred, and reducing, using the load controller, one or more auxiliary electrical loads in the auxiliary system thereby preventing tripping of one or more auxiliary electrical components or tripping of the entire wind turbine. The present invention also relates to a wind turbine arranged to perform this method.

### FIELD OF THE INVENTION

The present invention relates to a load reduction method and a wind turbine load reduction system adapted to reduce loads in an auxiliary system of the wind turbine during undervoltage events, such as long term undervoltage events.

### BACKGROUND OF THE INVENTION

When modern wind turbines remain connected to the power grid during undervoltage events the currents in the auxiliary systems of the wind turbines increase due to constant power loads in the auxiliary systems. The constant power in the auxiliary systems loads may originate from various loads, such as variable frequency drives (VFDs) for, for example, cooling fans, pumps etc.

The current increase in the auxiliary systems is disadvantageous in that it increases the voltage drops across one or more auxiliary electrical components in the auxiliary systems which may lead to tripping of auxiliary electrical components eventually causing the entire wind turbine to trip. In offshore wind power plants this is very problematic as also entire wind power plant may trip at once.

Increased currents in auxiliary systems of wind turbine may, in general, be complied with by using larger auxiliary electrical components, thicker cables, larger motors etc. However, this approach is disadvantageous since it is very expensive to implement.

Thus, there is a need for a method and a system that prevents tripping of wind turbines, and potentially tripping of entire wind power plants, during undervoltage events, such as long term undervoltage events.

It may thus be seen as an object of embodiments of the present invention to provide a method and a system that prevents tripping of wind turbines during undervoltage events, such as long term undervoltage events.

### DESCRIPTION OF THE INVENTION

The above-mentioned object is complied with by providing, in a first aspect, a method for operating a wind turbine during an undervoltage event where a grid voltage drops to an undervoltage value, wherein the wind turbine comprises a generator being operatively connected to a power grid, an auxiliary system comprising one or more auxiliary electrical components and one or more auxiliary electrical loads, an auxiliary transformer being operatively connected on a primary side to the generator and to the power grid, and being operatively connected on a secondary side to the auxiliary system, and a load controller being arranged to reduce one or more auxiliary electrical loads in the auxiliary system in response to a detected undervoltage event, the method comprising the steps of
determining, using the load controller, that an undervoltage event has occurred, and
reducing, using the load controller, one or more auxiliary electrical loads in the auxiliary system thereby preventing tripping of one or more auxiliary electrical components or tripping of the entire wind turbine.

Thus, the present invention relates, in a first aspect, to a method for preventing that one or more auxiliary electrical components of a wind turbine, or an entire wind turbine, trips during an undervoltage event where the wind turbine is expected to remain connected to the power grid, such as to support power grid with reactive power.

In the present context an undervoltage event may have occurred when the grid voltage has dropped to for example 0.85-0.90 pu for a certain period of time, such as 0.87 for one 1 hour. It should be noted that the voltage range may be different from 0.85-0.90 pu, and it may be dictated by grid codes at the site of the wind turbine. A power grid voltage of 0.85 pu corresponds to 85% of the nominal power grid voltage, i.e. the power grid voltage at normal operating conditions. Normal operating conditions may be considered to have been reached when the power grid voltage exceeds 0.90 pu.

The generator of the wind turbine may be driven by a set of rotatably mounted rotor blades which may be pitched in and out of the wind depending on the operating conditions, such as the wind speed. A gearbox may be inserted between the rotor blades and the generator which may have a nominal power of up to 15 MW. Moreover, the generator may provide power to the power grid via a power converter, such as a full-scale power converter.

The one or more auxiliary electrical components of the wind turbine's auxiliary system may be responsible for handling one or more auxiliary functions performed by the wind turbine. Thus, the one or more auxiliary electrical components may perform functions such as yawing, pitching, heating, control of hydraulic systems, etc. The one or more auxiliary electrical loads may be responsible for various cooling functions, such as cooling the generator, the power converter, the gearbox, the one or more auxiliary electrical components etc. In order to handle these cooling functions the one or more auxiliary electrical loads may each comprise a VFD, an electric motor and a cooling fan secured to the shaft of the electric motor. The speed of rotation of the electric motors depends on the frequency provided by the respective VFDs—the higher the frequency the higher the speed of rotation of the electric motors.

With respect to power load, the load caused by the one or more auxiliary electrical loads may be reduced by lowering the operating frequency provided by the VFDs as this reduces the speed of rotation of the electric motors. In general, if the current to an electric motor is reduced by 50% a four-fold power reduction for that electric motor is obtained. Thus, if an undervoltage event is detected the load controller may be arranged to lower the speed rotation of one or more electric motors thereby preventing tripping of one or more auxiliary electrical components of the wind turbine, or tripping of the entire wind turbine.

The undervoltage event may be detected via one or more measurements of the voltage of the power grid, or via measurement of one or more local voltages in the auxiliary system of the wind turbine. The power grid voltage may be measured as a single point measurement (single or multiphase) on the primary side of the auxiliary transformer. Alternatively, one or more local voltages (single or multiphase) may be measured in the auxiliary system of the wind turbine, i.e. on the secondary side of the auxiliary transformer. The one or more local voltages in the auxiliary system may be measured at (or near) the one or more auxiliary electrical components and/or at (or near) the one or more auxiliary electrical loads.

If the power grid voltage is determined via a voltage measurement on the primary side of the auxiliary transformer the winding ratio of a potential grid transformer may be taking into consideration when determining the power grid voltage. Similarly, if the power grid voltage is determined via one or more local voltage measurements on the secondary side of the auxiliary transformer the winding ratio of both a potential grid transformer and the auxiliary transformer may be taking into consideration when determining the power grid voltage.

As already mentioned, the one or more auxiliary electrical loads of the auxiliary system may comprise one or more VFDs arranged to control the speed of rotation of electric motors, i.e. the speed of rotation of cooling fans for cooling the generator, the power converter, the gearbox, the one or more auxiliary electrical components etc. In response to a detected undervoltage event the method may comprise the step of reducing one or more speed references to the VFDs. The reduced one or more speed references may be different (if more than two speed references) and they may be provided to selected and/or prioritised VFDs. The reduced one or more speed references to the respective VFDs may be determined and dispatched by the load controller.

Whether a VFD is selected and/or prioritised may relate to its function in the wind turbine. Thus, a VFD that is involved in cooling the generator may be considered more important and thus prioritized over a VFD that is involved in cooling for example the yawing system. Alternatively, all speed references to all VFDs may be reduced with the same value in response to a detected undervoltage event. This approach is advantageous due to its relative simple implementation.

In general, the speed references to the VFDs may be reduced by reducing an operating frequency of the VFDs with up to 20% which may lead to a power reduction in the range of 50-75% depending on the load type connected to the VFD and the size of the load.

The method according to the first aspect may further comprise the step of reducing, using the load controller, one or more auxiliary electrical loads in the auxiliary system in response to additional parameters, such as the site of the wind turbine and/or a measured or predetermined ambient temperature. Thus, other parameters may be decisive for reducing the load caused by one or more auxiliary electrical loads. For example, if the site of the wind turbine or wind power plant is known to have notoriously low ambient temperatures the amount of cooling provided to for example the generator and the power converter may be reduced beforehand. If an undervoltage event is then detected an even further reduced cooling of the generator and the power converter might not be needed.

Finally, the method may further comprise the step of terminating the reduced load operation of the one or more auxiliary electrical loads in the auxiliary system when the undervoltage event has terminated. Thus, when the undervoltage event has terminated the operating conditions of the wind turbine may return to normal.

In a second aspect the present invention relates to a wind turbine comprising
a generator being operatively connected to a power grid,
an auxiliary system comprising one or more auxiliary electrical components and one or more auxiliary electrical loads, and
an auxiliary transformer being operatively connected on a primary side to the generator and to the power grid, and being operatively connected on a secondary side to the auxiliary system,
   wherein the wind turbine further comprises a load controller arranged to reduce one or more auxiliary electrical loads in the auxiliary system in response to a detected undervoltage event where the grid voltage drops to an undervoltage value.

Thus, the present invention relates, in a second aspect, to a wind turbine capable of performing the method of the first aspect, i.e. performing, using the load controller, a method for preventing that one or more auxiliary electrical components of the wind turbine, or the entire wind turbine, trips during an undervoltage event where the wind turbine is expected to remain connected to the power grid, such as to support power grid with reactive power.

In the present context, and as already mentioned in relation to the first aspect, an undervoltage event may have occurred when the grid voltage has dropped to for example 0.85-0.90 pu for a certain period of time, such as 0.87 pu for 1 hour. It should again be noted that the voltage range may be different from 0.85-0.90 pu, and the voltage range may be dictated by grid codes at the site of the wind turbine. As already mentioned a power grid voltage of 0.85 pu corresponds to 85% of the nominal power grid voltage, i.e. the power grid voltage at normal operating conditions. Again, normal operating conditions may be considered to have been reached when the power grid voltage exceeds 0.90 pu.

The generator of the wind turbine may be driven by a set of rotatably mounted rotor blades which may be pitched in and out of the wind depending on the operating conditions, such as the wind speed. A gearbox may be inserted between the rotor blades and the generator which may have a nominal power of up to 15 MW. Moreover, the generator may provide power to the power grid via a power converter, such as a full-scale power converter. The site of the wind turbine may be either onshore or offshore, and the wind turbine may form part of the wind power plant.

As already mentioned, the one or more auxiliary electrical components of the wind turbine's auxiliary system may be responsible for handling one or more auxiliary functions performed by the wind turbine. Thus, the one or more auxiliary electrical components may perform functions such as yawing, pitching, heating, control of hydraulic systems, etc.

The one or more auxiliary electrical loads may be responsible for various cooling functions, such as cooling the generator, the power converter, the gearbox, the one or more auxiliary electrical components etc. In order to handle these cooling functions the one or more auxiliary electrical loads may each comprise a VFD, an electric motor and a cooling fan secured to the shaft of the electrical motor. The speed of rotation of the electric motors depends on the frequency provided by the respective VFDs—the higher the frequency the higher the speed of rotation of the electric motors.

With respect to power load, the load caused by the one or more auxiliary electrical loads may be reduced by lowering the operating frequency provided by the VFDs as this reduces the speed of rotation of the electric motors. In general, and as already mentioned, if the current to an electric motor is reduced by 50% a four-fold power reduction for that electric motor is obtained. Thus, if an undervoltage event is detected the load controller may be arranged to lower the speed rotation of one or more electric motors thereby preventing tripping of one or more auxiliary electrical components of the wind turbine, or tripping of the entire wind turbine. The load controller may form part of a controller of the wind turbine, such as part of a main controller of the wind turbine.

The load controller may be arranged to detect an undervoltage event via one or more measurements of the voltage of the power grid, or via measurement of one or more local voltages in the auxiliary system of the wind turbine. The power grid voltage may be measured as a single point measurement (single or multiphase) on the primary side of the auxiliary transformer. Alternatively, one or more local voltages (single or multiphase) may be measured in the auxiliary system of the wind turbine, i.e. on the secondary side of the auxiliary transformer. The one or more local voltages in the auxiliary system may be measured at (or near) the one or more auxiliary electrical components and/or at (or near) the one or more auxiliary electrical loads.

If the power grid voltage is determined via a voltage measurement on the primary side of the auxiliary transformer the winding ratio of a potential grid transformer may be taking into consideration when determining the power grid voltage. Similarly, if the power grid voltage is determined via one or more voltage measurements on the secondary side of the auxiliary transformer the winding ratio of both a potential grid transformer and the auxiliary transformer may be taking into consideration when determining the power grid voltage.

As already mentioned, the one or more auxiliary electrical loads of the auxiliary system may comprise one or more VFDs arranged to control the speed of rotation of electric motors, i.e. the speed of rotation of cooling fans for cooling the generator, the power converter, the gearbox, the one or more auxiliary electrical components etc. In response to a detected undervoltage event the load controller may reduce one or more speed references to the VFDs. The reduced one or more speed references may be different (if there are more than two speed references) and they may be provided to selected and/or prioritised VFDs. The reduced one or more speed references to the respective VFDs may be determined and dispatched by the load controller.

Whether a VFD is selected and/or prioritised may relate to its function in the wind turbine. Thus, a VFD that is involved in cooling the generator may be considered more important and thus prioritized over a VFD that is involved in cooling for example the yawing system. Alternatively, all speed references to all VFDs from the load controller may be reduced with the same value in response to a detected undervoltage event. This approach is advantageous due to its simple implementation.

In general, the speed references to the VFDs from the load controller may be reduced by reducing an operating frequency of the VFDs with up to 20% which may lead to a power reduction in the range of 50-75% depending on the load type connected to the VFD and the size of the load.

The load controller may furthermore be arranged to reduce the one or more auxiliary electrical loads in the auxiliary system in response to additional parameters, such as the site of the wind turbine and/or a measured or predetermined ambient temperature. Thus, other parameters may be decisive for reducing the load caused by one or more auxiliary electrical loads. For example, if the site of the wind turbine or wind power plant is known to have notoriously low ambient temperatures this may be stored in the load controller, and the amount of cooling provided to for example the generator and the power converter may be reduced beforehand. If an undervoltage event is then detected an even further reduced cooling of the generator and the power converter might not be needed.

Finally, the load controller may moreover be arranged to terminate the reduced load operation of the one or more auxiliary electrical loads in the auxiliary system when the undervoltage event has terminated. Thus, when the undervoltage event has terminated the operating conditions of the wind turbine may return to normal.

In a third aspect the present invention relates to a wind power plant comprising one or more wind turbines according to the second aspect. In the present context a wind power plant may be seen as a group of typically tens or hundreds of wind turbines with a point of common coupling (PCC) to an external power grid. The wind power plant may be either onshore or offshore, or even a combination thereof.

In general, the various aspects of the present invention may be combined and coupled in any way possible within the scope of the invention. These and other aspects, features and/or advantages of the present invention will be apparent from and elucidated with reference to the embodiments described hereinafter.

### BRIEF DESCRIPTION OF THE DRAWINGS

The present invention will now be described with reference to the accompanying drawings wherein

FIG. 1 shows a schematic block diagram of a wind turbine, and

FIG. 2 show a flow chart of the method of the present invention.

### DETAILED DESCRIPTION OF THE INVENTION

In general, the present invention relates to a method for reducing the load in an auxiliary system of wind turbine during undervoltage events, such as long term undervoltage events, as well as a wind turbine capable of performing this load reduction method. The method and wind turbine according to the present invention are thus adapted to reduce loads in an auxiliary system of the wind turbine during undervoltage events, and thus avoid that the wind turbine potentially trips due to increased currents and associated increased voltage drops across auxiliary electrical components in the auxiliary system of the wind turbine.

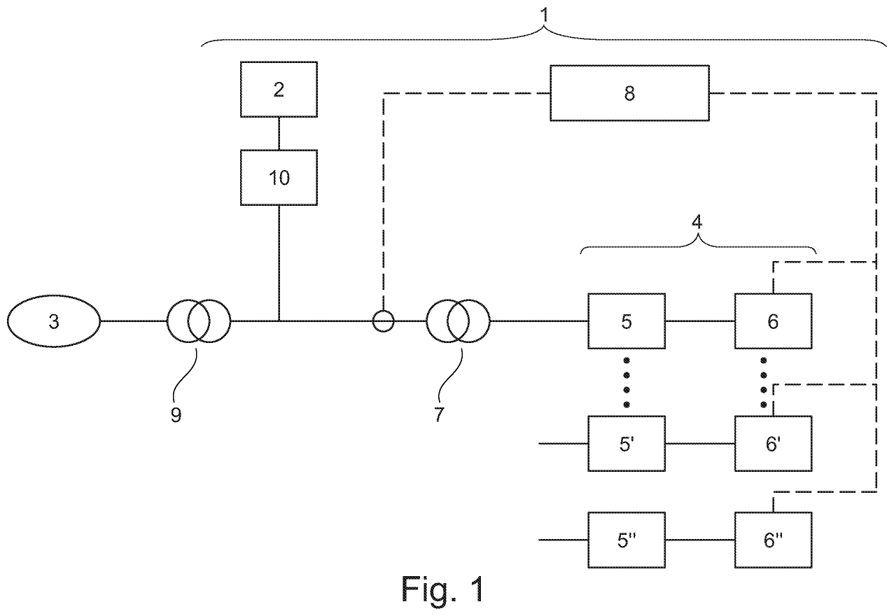

FIG. 1 shows a single line diagram of a wind turbine 1 according to an embodiment of the present invention. The wind turbine 1 comprises a power generator 2 being electrically connected to a power grid 3 via a transformer 9 and a power converter 10. The generator 2 and the power grid 3 are electrically connected on a primary side of an auxiliary transformer 7. The auxiliary transformer 7 is on a secondary side electrically connected to an auxiliary system 4 which comprises one or more auxiliary electrical components 5, 5′, 5″ and one or more auxiliary electrical loads 6, 6′, 6″. Although the one or more auxiliary electrical components 5, 5′, 5″ and one or more auxiliary electrical loads 6, 6′, 6″ in FIG. 1 are depicted as AC devices they may, alternatively, also involve DC devices, such as DC motors in combination with appropriate drive arrangements.

The generator 2 of the wind turbine 1 is typically driven by a set of rotatably mounted rotor blades (not shown) which may be pitched in and out of the wind depending on the operating conditions, such as the wind speed. A gearbox (also not shown) may be inserted between the rotor blades and the generator 2. The generator 2 and the power converter 10, which may be a full-scale power converter, may have a nominal power of up to 15 MW delivered via three phases.

The one or more auxiliary electrical components 5, 5′, 5″ may be responsible for handling one or more auxiliary functions performed by the wind turbine 1, such as yawing, pitching, heating, control of hydraulic systems, etc. The one or more auxiliary electrical loads 6, 6′, 6″ may for example handle various cooling functions, such as cooling the generator 2, the converter 10, a gearbox, the one or more auxiliary electrical components 5, 5′, 5″ etc. In order to handle such cooling functions the one or more auxiliary electrical loads 6, 6′, 6″ may each comprise a VFD, an electric motor and a cooling fan secured to a shaft of the electric motor. The operating frequency of the VFD controls the rotational speed of the electric motor and thus the cooling capability.

The wind turbine 1 may be arranged to comply with modern grid codes. This may imply for example that the wind turbine 1 should be adapted to remain electrically connected to the power grid 3 during an undervoltage event where the power grid voltage may drop to for example 0.85 pu over a longer period of time. The term “a longer period of time” may, according to some grid codes, be up to 1 hour. As already mentioned, a power grid voltage of 0.85 pu corresponds to a grid voltage level of 85% of the nominal grid voltage, i.e. the grid voltage at normal operating conditions.

With a reduced power grid voltage of for example 0.85 pu the currents in the auxiliary system 4 inevitably increase if the loads caused by the one or more auxiliary electrical loads 6, 6′, 6″ remain constant. The current increase in the auxiliary system 4 causes the voltage drops across the one or more auxiliary electrical components 5, 5′, 5″ to increase due to for example the associated internal resistances, and these increased voltage drops may lead to tripping and thus malfunctioning of one or more auxiliary electrical components 5, 5′, 5″. Tripping of one or more auxiliary electrical components 5, 5′, 5″ should be avoided as it may potentially lead to tripping of the entire wind turbine 1. However, if the load caused by the one or more auxiliary electrical loads 6, 6′, 6″ is reduced the currents and the associated voltages drops in the auxiliary system 4 may be controlled so that the risk of tripping is significantly reduced.

In order to avoid tripping, the wind turbine 1 comprises a load controller 8 which may form part of a controller, such as a main controller, of the wind turbine 1. The load controller 8 may be arranged to reduce the load caused by one or more auxiliary electrical loads 6, 6′, 6″ in the auxiliary system 4 in response to a detected undervoltage event. As depicted in FIG. 1 the load controller 8 may be arranged to detect an undervoltage event via a measurement of the power grid voltage on the primary side of the auxiliary transformer 7. If the power grid voltage is determined via a voltage measurement on the primary side of the auxiliary transformer 7 the winding ratio of the grid transformer 9 may be taking into consideration when determining the power grid voltage.

Alternatively (although not depicted in FIG. 1), the load controller 8 may be arranged to detect an undervoltage event via measurement of one or more local voltages in the auxiliary system 4, such as one or more local voltages at the one or more auxiliary electrical components 5, 5′, 5″ and/or at the one or more auxiliary electrical loads 6, 6′, 6″. If the power grid voltage is determined via one or more local voltage measurements on the secondary side of the auxiliary transformer 7, i.e. in the auxiliary system 4, the winding ratio of both the grid transformer 9 and the auxiliary transformer 7 may be taking into consideration when determining the power grid voltage.

In case an undervoltage event is detected the load controller 8 may be arranged to reduce one or more speed references to the respective VFDs in the one or more auxiliary electrical loads 6, 6′, 6″. As already discussed the one or more speed references is/are reduced by lowering the operating frequency of one or more VFDs and thus lowering the speed of rotation of electric motors driven by the VFDs. The reduced speed references may be provided to selected and/or prioritised VFDs, and the provided speed references may be different. Whether a VFD is considered selected and/or prioritised may relate to its function in the wind turbine. For example, a VFD that is involved in cooling the generator 2 may be considered more important and thus prioritized over a VFD that is involved in cooling for example the yawing system.

Alternatively, the load controller 8 may be arranged to reduce all speed references to all VFDs with the same value in order to simplify the control scheme. In terms of implementation the load controller 8 may be arranged to reduce speed references to the VFDs by reducing an operating frequency of the VFDs with up to 20%.

When the undervoltage event has ended, i.e. when the power grid voltage is again approaching its nominal voltage level, the speed references to the respective VFDs can also return to their normal, i.e. non-reduced, values.

Thus, according to the present invention the wind turbine 1 can, in a safe manner, remain connected to the power grid 3 during undervoltage events without the risk of tripping, and without requiring service personnel to access the wind turbine 1.

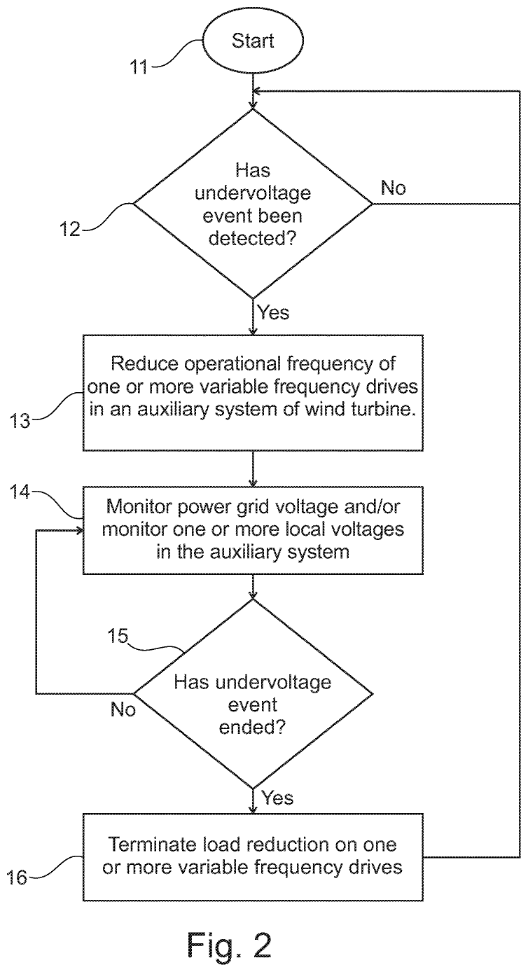

FIG. 2 shows a flow chart illustrating a method according to an embodiment of the present invention. The method is initiated in step 11, in which a wind turbine is operated at normal operating conditions.

In step 12, it is established whether an undervoltage event has occurred or not. In case the grid voltage has not dropped to an undervoltage value, the wind turbine continues to operate at normal operating conditions.

In case that step 12 reveals that the grid voltage has dropped to an undervoltage value, this indicates that an undervoltage event has occurred. The undervoltage value may be in the range 0.85-0.90 pu which corresponds to 85-90% of the nominal grid voltage. As already discussed the undervoltage event may be detected via one or more measurements of the power grid voltage, or via measurements of one or more local voltages in the auxiliary system 4, cf. FIG. 1, such as one or more local voltages measured at the one or more auxiliary electrical components and/or at the one or more auxiliary electrical loads.

If the power grid voltage is determined via a voltage measurement on the primary side of the auxiliary transformer 7 in FIG. 2 the winding ratio of the grid transformer 9 may be taking into consideration when determining the power grid voltage. Similarly, if the power grid voltage is determined via one or more local voltage measurements on the secondary side of the auxiliary transformer 7, i.e. in the auxiliary system 4 of FIG. 1, the winding ratio of both the grid transformer 9 and the auxiliary transformer 7 may be taking into consideration when determining the power grid voltage.

In case that an undervoltage event is detected the method proceeds to step 13, where the load caused by one or more auxiliary electrical loads is reduced by reducing the operational frequency of one or more VFDs in the auxiliary system. By reducing the load caused by one or more auxiliary electrical loads, the current and the associated voltage drops in the auxiliary system are significantly reduced.

The reduction of the operational frequency of the VFDs may be implemented in various ways. For example, reducing the operational frequency may apply to all VFDs, and the reduction may be the same for all VFDs. Alternatively, the operational frequency of only selected and/or prioritized VFDs may be reduced. The selected and/or prioritized VFDs may be associated with the auxiliary loads at which local voltage measurements indicate that an undervoltage event has occurred. The selected and/or prioritised VFDs may also be prioritised over other VFDs in accordance with a predetermined priority list which may be established with respect to safe operation of the wind turbine. For example, a VFD that is involved in cooling the generator may be considered more important and thus prioritized over a VFD that is involved in cooling for example the yawing system.

In step 14, the power grid voltage and/or one or more local voltages in the auxiliary system are monitored. As mentioned above the one or more local voltages may be measured at the one or more auxiliary electrical components and/or at the one or more auxiliary electrical loads.

Based on the monitoring performed in step 14, it is in step 15 established whether the undervoltage event has ended or not. If the monitoring in step 14 reveals that the power grid voltage again approaches its nominal value the load reduction operation of the VFDs is terminated, and the VFDs are returned to normal operation, cf. step 16. On the other hand, if the monitoring in step 14 reveals that the power grid voltage is still at an undervoltage value the load reduction of the VFDs is continued.

Although the present invention has been discussed in the foregoing with reference to exemplary embodiments of the invention, the invention is not restricted to these particular embodiments which can be varied in many ways without departing from the invention. The discussed exemplary embodiments shall therefore not be used to construe the appended claims strictly in accordance therewith. On the contrary, the embodiments are merely intended to explain the wording of the appended claims, without intent to limit the claims to these exemplary embodiments. The scope of protection of the invention shall therefore be construed in accordance with the appended claims only, wherein a possible ambiguity in the wording of the claims shall be resolved using these exemplary embodiments.

1. A method for operating a wind turbine during an undervoltage event where a grid voltage drops to an undervoltage value, wherein the wind turbine comprises a generator being operatively connected to a power grid, an auxiliary system comprising one or more auxiliary electrical components and one or more auxiliary electrical loads, an auxiliary transformer being operatively connected on a primary side to the generator and to the power grid, and being operatively connected on a secondary side to the auxiliary system, and a load controller being arranged to reduce one or more auxiliary electrical loads in the auxiliary system in response to a detected undervoltage event, the method comprising:
determining, using the load controller, that an undervoltage event has occurred, and
reducing, using the load controller, one or more auxiliary electrical loads in the auxiliary system thereby preventing tripping of one or more auxiliary electrical components or tripping of the entire wind turbine.

2. A method according to claim 1, wherein the undervoltage event is detected via one or more measurements of the voltage of the power grid, or via measurement of one or more local voltages in the auxiliary system.

3. A method according to claim 2, where the one or more local voltages in the auxiliary system are measured at the one or more auxiliary electrical components and/or at the one or more auxiliary electrical loads.

4. A method according to claim 1, wherein the one or more auxiliary electrical loads of the auxiliary system comprise one or more variable frequency drives, and wherein the method further comprises reducing one or more speed references to the variable frequency drives in response to a detected undervoltage event, such as reducing all speed references to all variable frequency drives are reduced with the same value in response to a detected undervoltage event.

5. A method according to claim 4, wherein the speed references to the variable frequency drives are reduced by reducing an operating frequency of the variable frequency drives with up to 20%.

6. A method according to claim 1, wherein the undervoltage value is within 0.85-0.90 pu.

7. A method according to claim 1, further comprising reducing, using the load controller, one or more auxiliary electrical loads in the auxiliary system in response to additional parameters, such as the site of the wind turbine and/or a measured or predetermined ambient temperature.

8. A method according to claim 1, further comprising terminating the reduced load operation of the one or more auxiliary electrical loads in the auxiliary system when the undervoltage event has terminated.

9. A wind turbine comprising
a generator being operatively connected to a power grid,
an auxiliary system comprising one or more auxiliary electrical components and one or more auxiliary electrical loads, and
an auxiliary transformer being operatively connected on a primary side to the generator and to the power grid, and being operatively connected on a secondary side to the auxiliary system,
wherein the wind turbine further comprises a load controller arranged to reduce one or more auxiliary electrical loads in the auxiliary system in response to a detected undervoltage event where the grid voltage drops to an undervoltage value.

10. A wind turbine according to claim 9, wherein the load controller is arranged to detect an undervoltage event via one or more measurements of the voltage of the power grid, or via measurement of one or more local voltages in the auxiliary system, such arranged to measure the one or more local voltages in the auxiliary system at the one or more auxiliary electrical components and/or at the one or more auxiliary electrical loads.

11. A wind turbine according to claim 9, wherein the one or more auxiliary electrical loads of the auxiliary system comprise one or more variable frequency drives, and wherein the load controller is arranged to reduce one or more speed references to the variable frequency drives in response to a detected undervoltage event, such as arranged to reduce all speed references to all variable frequency drives with the same value in response to a detected undervoltage event.

12. A wind turbine according to claim 11, wherein the load controller is arranged to reduce speed references to the variable frequency drives by reducing an operating frequency of the variable frequency drives with up to 20%.

13. A wind turbine according to claim 9, wherein the undervoltage value is within 0.85-0.90 pu.

14. A wind turbine according to claim 9, wherein the load controller is furthermore arranged to reduce the one or more auxiliary electrical loads in the auxiliary system in response to additional parameters, such as the site of the wind turbine and/or a measured or predetermined ambient temperature.

15. (canceled)
